(19) United States
(12) Patent Application Publication
(10) Pub. No.: US 2005/0036641 A1
(43) Pub. Date: Feb. 17, 2005

(54) Megaphone sign apparatus and method

(76) Inventors: Kwun-Wing W. Cheung, Shoreline, WA (US); Bethany L. Franko, Seattle, WA (US)

Correspondence Address: HARNESS, DICKEY & PIERCE, P.L.C., P.O. BOX 828, BLOOMFIELD HILLS, MI, 48303, US

(21) Appl. No.: 10/641,564

(22) Filed: Aug. 15, 2003

(51) Int. Cl. H04B 5/00; H04R 27/00

(52) U.S. Cl. 381/334; 381/79; 381/82

(57) ABSTRACT

An apparatus for providing both a visual message and audio information simultaneously. The apparatus includes a display sign including an image or indicia thereon which provides visual information to an individual or a group of individuals being addressed by a user. The apparatus further includes a loud speaker and a lightweight, miniature microphone which is worn or carried by the user. The microphone provides an input signal to a microphone and amplifier module which drives the loud speaker. An optional volume control allows the volume of the audio signal generated by the loud speaker to be adjusted by the user. The apparatus forms a lightweight, easy to carry and convenient means for allowing a user to provide both visual and audio information simultaneously. The apparatus can easily be held with one or both hands of the user.

### FIELD OF THE INVENTION

The present invention relates to display devices, and more particularly to a display sign incorporating a megaphone for enabling a user to simultaneously display a message and provide audio information relating to the message.

### BACKGROUND OF THE INVENTION

Hand held signs are often used in combination with spoken announcements. In many cases, an individual who is holding the sign would be required to either raise his/her voice to address a group, or alternatively use a portable megaphone so that sufficient voice amplification is provided to reach all of the individuals in the group. Obviously, carrying two items is certainly inconvenient and somewhat of a burden to the individual. It would be highly desirable to provide some type of display sign or device which incorporates a loudspeaker function to allow the user to simultaneously and conveniently provide a visual message, as well as an audio message, to the group. Such an apparatus would be highly useful in a variety of applications such as when providing safety instructions on board an aircraft, or even by a tour guide addressing a small or large size group. If such an apparatus was sufficiently small as to be easily carried about and held with one or two hands, this would further enhance the efficacy of the device.

An ancillary benefit of such a device as described above would be that the user would not have to have his/her face blocked when speaking, such as would be the case with a conventional megaphone, which would need to be held in front of the face of the user. If the device could allow the user to provide an audio message through a miniature microphone, such as is commonly used with present day cell phones for hands free cell phone use, this would enable the user to establish a better rapport with the individuals in the group that he/she is addressing.

### SUMMARY OF THE INVENTION

The present invention is directed to a display sign incorporating an audio loud speaker. The sign also includes a provision for a microphone to be used with the sign to allow a user to provide voice commands or other verbal information which can be reproduced by the speaker in amplified form. The apparatus effectively forms a megaphone that has the added capability to display visual information. A principal advantage of the present invention is that both a visual message and an audio message can be simultaneously provided to an individual or group of individuals. The apparatus is also very lightweight and compact so that it can be easily transported by an individual without any other equipment, or even carried with one or both hands of the user.

In one preferred embodiment the display sign incorporates a handle portion allowing the user to easily grasp and hold up the apparatus with a single hand. In another preferred embodiment a display sign is formed which includes a handle portion having a collapsing, tripod-like stand for enabling the display sign to be rested in an upright position on a ground surface. In both embodiments an amplifier system is included which includes an input for a miniature microphone or a like transducer which can be easily held or worn by a user. Speaking into the microphone provides an input to the amplifier system. The amplifier system uses this input signal to provide an output to an audio driver associated with the loudspeaker, which is fixedly secured to a portion of the display panel. Optionally, the display sign may include a volume control which is conveniently located to enable a user to easily adjust the volume of the audio message being generated by the loudspeaker.

In another preferred embodiment the sign is worn either as a sign on the front and back of a person's body or as a hat or other type of “clothing”.

The present invention is anticipated to be highly useful in a variety of applications, for example, on board an aircraft to provide both visual and audible information regarding safety procedures, or even in connection with guided tours where an individual is required to provide both visual and audio information to one or a group of individuals.

Further areas of applicability of the present invention will become apparent from the detailed description provided hereinafter. It should be understood that the detailed description and specific examples are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a perspective view of an individual holding one preferred embodiment of the present invention;

FIG. 2 is a perspective view of the apparatus of FIG. 1 viewed from the rear;

FIG. 3 is a side view of the apparatus of FIG. 1;

FIG. 4 is a block diagram of the principal electronic components of one preferred embodiment of the present invention;

FIG. 5 is a rear perspective view of an alternative preferred embodiment of the present invention incorporating a retractable leg assembly;

FIG. 6 is a perspective view of a portion of the embodiment of FIG. 5 but showing the leg assembly in its operative position;

FIG. 7 is a perspective view of the alternative preferred embodiment of FIGS. 5 and 6 in use by a user;

FIG. 8 is a perspective view of an alternative preferred embodiment of the present invention in the form of a wearable display sign; and

FIG. 9 is a perspective view of an alternative preferred embodiment of the present invention in the form of a hat.

### DETAILED DESCRIPTION OF THE PREFERRED EMBODIMENTS

The following description of the preferred embodiment(s) is merely exemplary in nature and is in no way intended to limit the invention, its application, or uses.

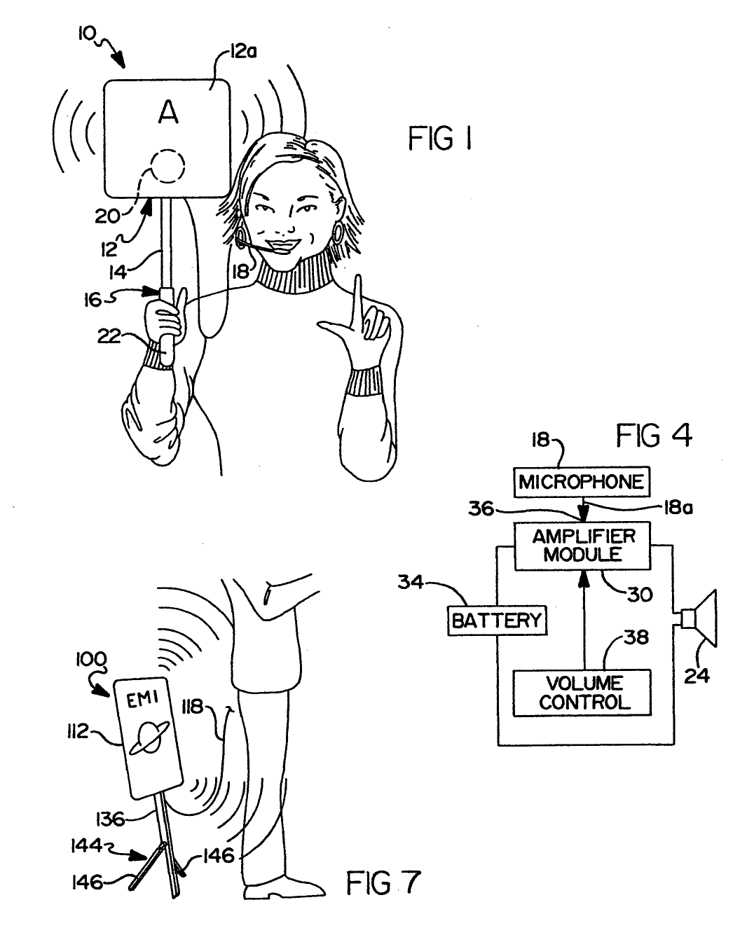

Referring to FIG. 1, there is shown a display apparatus 10 in accordance with a preferred embodiment of the present invention. The display apparatus 10 forms a megaphone that includes a sign that can be held with one or two hands of a user, and which is sufficiently lightweight so as to be easily carried about by the user.

The apparatus 10 includes a display sign 12 having a neck portion 14 and a handle portion 16. A lightweight, miniature microphone 18 is coupled to the sign 12 for enabling a user to provide an audio input signal to the apparatus 10. A flat panel audio loudspeaker 20 is secured to the display sign 12 preferably on a rear portion of the display sign, as will be described in greater detail momentarily.

It will be appreciated immediately, then, that the apparatus 10 enables a user to provide a visual message as well as a simultaneous audio message to another individual or group of individuals being addressed by the user. It is anticipated that the apparatus 10 will find utility in a wide range of applications, including but not limited to on board aircraft where safety instructions must be provided along with visual information to passengers on the aircraft. Another possible application is in connection with providing tours, where a tour guide is required to provide both visual and audio information to one or more individuals of a group. Still further applications are anticipated to be in law enforcement and entertainment, and virtually any other venue where it would be helpful/desirable to be able to provide both audio and visual information simultaneously to one or more other individuals.

The display sign 12 may comprise a wide variety of lightweight materials, but in one preferred form is comprised of plastic. A message may be printed, adhered or secured in any other suitable fashion to a front surface 12a of the display sign 12. The display sign 12 could also include clips or magnetic elements for releasably holding a placard or other form of sign thereto so that the visual message can be changed very quickly and easily by the user if needed. The neck portion 14, as well as the handle 16, could also be formed from a wide variety of suitable strong yet lightweight materials, for example, from a relatively high strength plastic. Handle 16 preferably incorporates a gripping surface 22 made from a material such as foam to form a more comfortable area which the user can grasp with one or both hands.

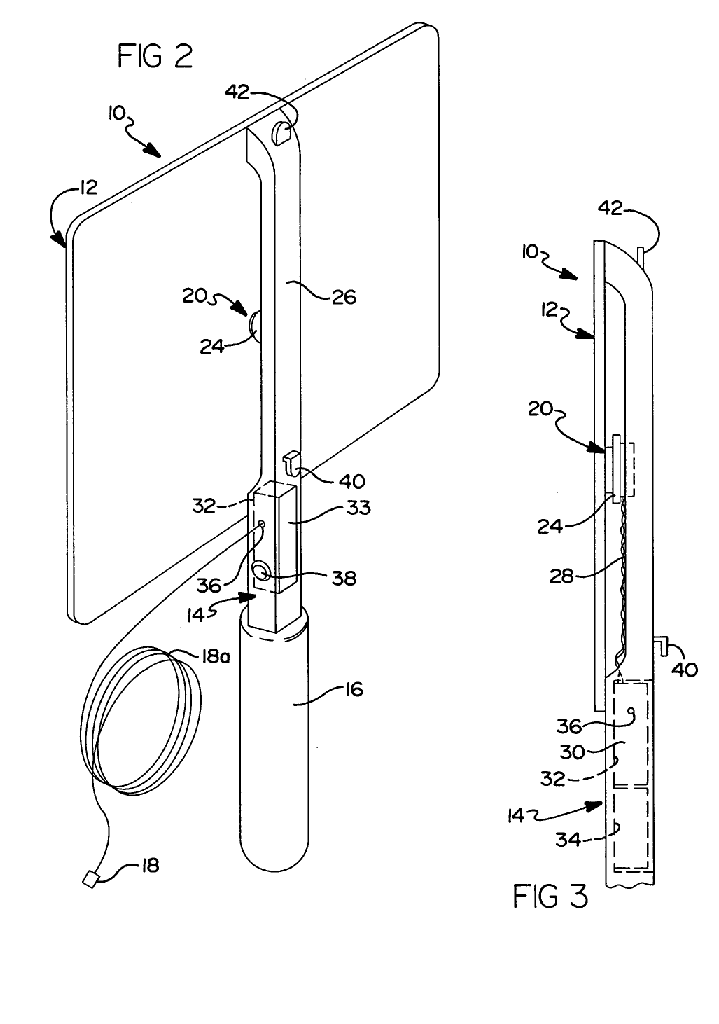

Referring to FIG. 2, the display sign 12 can be seen in greater detail. The loudspeaker 20 of the display sign 12 includes a flat panel driver (exciter) 24 which is secured such as by an adhesive or any other suitable means to an upper portion 26 of the neck portion 14. A suitable flat panel driver (exciter) for use with the apparatus 10 is available from Slab Sound of Auckland, New Zealand. The flat panel driver (exciter) 24 is coupled via a pair of electrical conductors 28 (FIG. 3) with a microphone and amplifier module 30 disposed in a recess 32 in the neck portion 14. For access to the module 30 a door 33 (FIG. 2) may be provided. The module 30 is powered by a battery pack 34 also disposed within the recess 32 in the neck portion 14. The battery pack 34 may be a rechargeable battery pack (or a single re-chargeable battery) or simply a non-rechargeable, lead acid battery that is discarded after its charge is depleted. In either event, the battery pack 34 is electrically coupled with the module 30 to provide power for powering the module. Other options for powering the sign may include mechanical and solar power depending on the application.

The microphone 18 may comprise either a miniature microphone that can be attached to clothing of the user, such as with microphones used with present day cell phones, or it may comprise a hand held microphone. In one form the microphone 18 includes a cable 18a which is coupled to an input 36 on the neck portion 14. The input 36 is in turn electrically coupled to an input of the microphone and amplifier module 30 so that output signals from the microphone 18 can be input to the module 30.

Optionally, a volume control 38 is included which is electrically coupled to the microphone and amplifier module 30 for adjusting the volume of the audio output of the flat panel driver (exciter) 24.

The upper portion 26 of the neck portion 14 further optionally includes a pair of microphone cable storage hooks 40 and 42 (FIG. 3) around which the microphone cable 18a (FIG. 2) can be wound when the microphone is not in use.

Referring to FIG. 4, a simplified block diagram of the various electronic components of the apparatus 10 is shown. It will be appreciated that the microphone and amplifier module 30 includes both a preamplifier and an amplifier suitable for amplifying the very low power output from the microphone 18 to a level suitable to drive the driver (excited) 24. While the volume control 38 is optional, it is anticipated that this feature will be highly useful to enable the user to tailor the volume output of the driver (excited) 24 to a comfortable level depending upon the distance the user is from the individual or group that he/she is addressing. If an AC power source is available, then the battery 34 could obviously be eliminated and the amplifier module 30 adapted for use, through a suitable rectifier circuit, with an AC power source. Other power sources such as solar power could also be used.

It will also be appreciated that wireless technology could be used to transmit the driving signals from the microphone and amplifier module 30 to the flat panel driver (exciter) 24. Still further, wireless technology could be used in connection with the microphone 18 to allow a wireless connection to be made with the module 30.

The flat panel loudspeaker 20, while shown disposed at a center of the display sign 12, could be disposed essentially at any point on the display sign 12. Alternatively, a plurality of flat panel loudspeakers could be secured on the display sign 12. In this manner the amplitude of the audio signal generated by the apparatus 10 can be controlled over a much wider amplitude range.

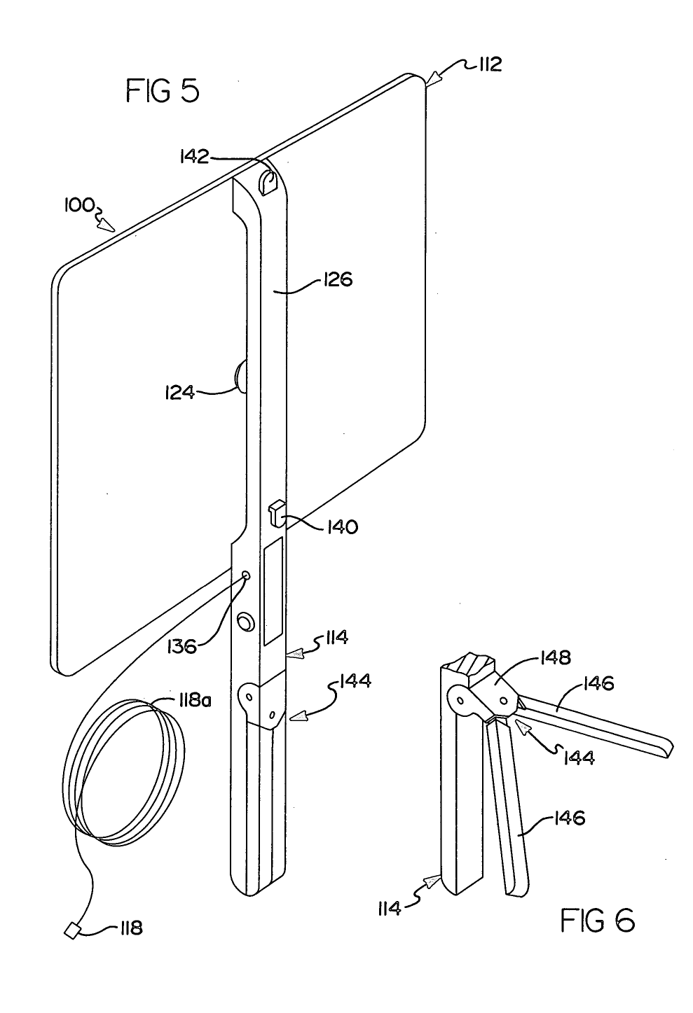

Referring now to FIGS. 5-7, an alternative preferred embodiment 100 of the display apparatus is illustrated. Apparatus 100 is essentially identical to apparatus 10, and common components have been designated with reference numerals increased by 100. The principal difference from apparatus 10 is that handle portion 116 includes a retractable stand 144 for allowing the apparatus 10 to form a self standing unit. The stand 144 incorporates a pair of retractable legs 146 which are pivotally coupled via a suitable bracket or a joint 148 to the neck portion 136, as shown in FIG. 6. The legs 146 can be easily retracted and generally blend in with the contour of the neck portion 116 to form a suitable area at which the user can grasp and support the apparatus 10 in the event the apparatus needs to be held up by the user. It will also be appreciated that any suitable platform or supporting structure could easily be integrated for use with the neck portion 116, provided same still enables the apparatus 100 to form a lightweight component that can be carried about by the user as needed. Advantageously, the retractable stand does not add appreciably to the overall weight of the apparatus 100, and thus the apparatus can still be carried about easily and held up with a single hand if the need arises.

Each of the preferred embodiments of the present invention provide the benefit of allowing a user to provide both a visual message as well as an audible message to another individual or group of individuals. Since the user is not required to hold the apparatus 10 or 100 in front of his/her face, the user is better able to make eye contact with and establish a rapport with an individual or group of individuals being addressed by the user.

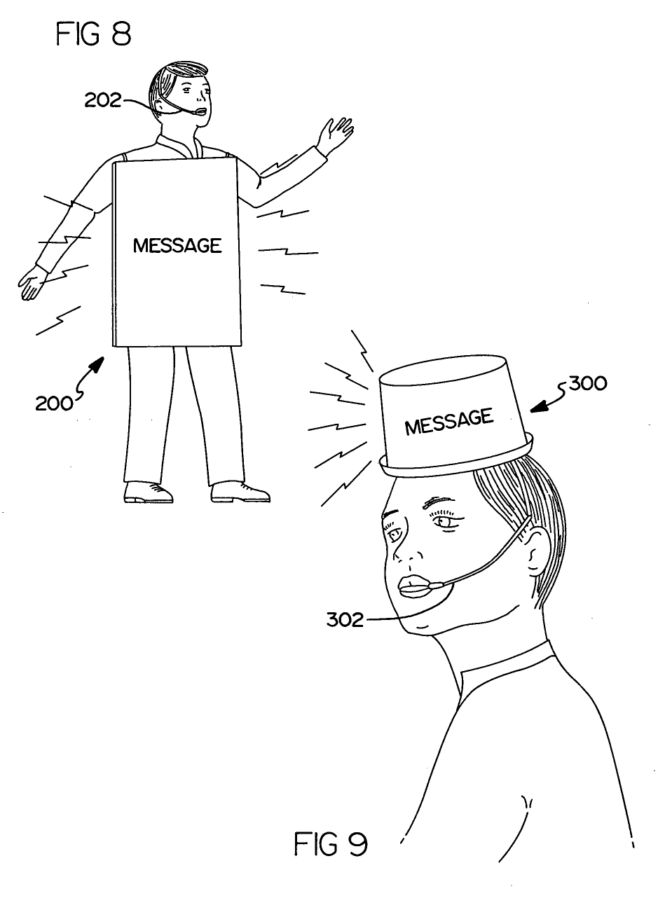

Referring to FIG. 8, an alternative preferred embodiment of the present invention is shown in the form of a sign 200 that can be worn by a user. The sign 200 is otherwise functionally identical to the previously discussed embodiments, and allows a user to provide an amplified audible message via a microphone 202. The sign can be supported by suitable straps 204 over the shoulders of a user or in any other manner that is comfortable and convenient for the user.

FIG. 9 illustrates a hat 300 in accordance with an alternative preferred embodiment of the present invention. The hat 300 provides a visual message, as well as a microphone 302 for enabling a user to provide an audible message.

The present invention thus forms a convenient, lightweight and easy to use means for providing both visual and audio information to an individual or group of individuals which the user is addressing. Since the apparatus 10 or 100 is very lightweight, the apparatus can be carried about conveniently by the user without the need for any other equipment.

While various preferred embodiments have been described, those skilled in the art will recognize modifications or variations which might be made without departing from the inventive concept. The examples illustrate the invention and are not intended to limit it. Therefore, the description and claims should be interpreted liberally with only such limitation as is necessary in view of the pertinent prior art.

1. An apparatus comprising:
a display sign panel for providing a visual message;
an audio speaker supported from said display sign;
an audio amplifier supported from said display sign, for driving said audio speaker, said audio amplifier adapted to communicate with a microphone for enabling a user speaking into said microphone to provide an input signal to said audio amplifier; and
wherein said audio amplifier amplifies said input signal to produce an amplified input signal, and wherein said amplified input signal is used to drive said audio speaker to provide an audible message.

2. The apparatus of claim 1, wherein said display sign includes a stand.

3. The apparatus of claim 2, wherein said stand comprises a plurality of retractable legs that form a handle when in a retracted position.

4. The apparatus of claim 1, wherein said display sign includes a manually graspable handle portion for enabling a user to hold said apparatus with one or more hands.

5. The apparatus of claim 1, wherein said audio speaker comprises a flat panel loudspeaker.

6. The apparatus of claim 1, further comprising a battery supported from said display sign for powering said audio amplifier and said audio speaker.

7. The apparatus of claim 4, wherein said handle portion includes a battery for powering said audio amplifier and said audio speaker.

8. An apparatus for enabling an individual to simultaneously provide both a visual message and an audio message, the apparatus comprising:
a display sign panel adapted to display visual information, said display sign panel having a handle portion for enabling a user to comfortably hold said apparatus;
an audio speaker fixedly supported from said display sign panel for generating an audible signal;
an audio amplifier subsystem for generating an output signal to drive said audio speaker; and
an input device for converting a verbal signal from a user into an electrical output signal, said electrical output signal driving said amplifier and being reproduced in amplified form as said audible signal by said audio speaker.

9. The apparatus of claim 8, wherein said audio amplifier subsystem is disposed in said handle portion.

10. The apparatus of claim 8, wherein said audio speaker comprises a flat panel speaker.

11. The apparatus of claim 8, further comprising a battery for powering said amplifier subsystem and said audio speaker.

12. The apparatus of claim 8, further comprising a control located on said display sign panel for adjusting a volume of an audio signal generated by said audio speaker.

13. The apparatus of claim 8, wherein said audio speaker is secured to said display sign panel by an adhesive

14. The apparatus of claim 5, further comprising a retractable stand for supporting said display sign panel on a support surface.

15. A portable, sign apparatus readily carryable by an individual and operable to generate an audio signal and visual information, said apparatus comprising:
a sign panel for displaying visual information;
a flat panel speaker secured to said sign panel;
an amplifier subsystem for providing a signal to drive said speaker; and
a microphone in communication with said subsystem for enabling a user to provide a verbal signal that is amplified by said amplifier subsystem and reproduced by said speaker.

16. The apparatus of claim 15, wherein said sign panel includes a handle portion for enabling a user to hold said apparatus with at least one hand.

17. The apparatus of claim 15, further comprising a volume control disposed on said sign panel for enabling a user to adjust the volume of an audio signal generated by said speaker.

18. The apparatus of claim 15, further comprising a battery disposed on said sign panel for powering said subsystem.

19. The apparatus of claim 18, wherein said battery is disposed in a handle portion of said sign panel.

20. The apparatus of claim 15, wherein said sign panel is comprised of plastic.

21. The apparatus of claim 15, further comprising a stand assembly for supporting said sign panel on a support surface.

22. A method for forming a sign operable to simultaneously provide visual and audible messages, comprising:
using a hand holdable panel to display a visual message;
using a speaker supported from said panel to generate an audible message; and
using a microphone in communication with said speaker to enable an individual to generate an amplified audio message via said speaker while simultaneously displaying said visual message from said panel.

23. The method of claim 22, wherein using a speaker comprises using a flat panel speaker.

24. The method of claim 22, wherein using a panel comprises using a portable panel to display a visual message.

25. The method of claim 22, wherein using a microphone comprises using a volume control operably associated with said speaker to adjust a volume level of an audible message reproduced by said speaker.

26. The method of claim 22, wherein using a panel comprises using a panel having a handle portion that can be supported by one or more hands of a user.
